(19) United States
(12) Patent Application Publication
(10) Pub. No.: US 2012/0099405 A1
(43) Pub. Date: Apr. 26, 2012

(54) SPORTS TIMEKEEPING SYSTEM

(75) Inventors: Noam Lidor, D.N Hefer (IL); Ori Lekach, Givat Haim Meuhad (IL); Tal Stern, Givat Haim Meuhad (IL); Yoav Chen, Givat Haim Meuhad (IL)

(73) Assignee: PURE GAME SOLUTIONS LTD, D N Hefer (IL)

(21) Appl. No.: 13/378,207

(22) PCT Filed: Jun. 16, 2010
(86) PCT No.: PCT/IL10/00475

§ 371 Date: Dec. 14, 2011

Related U.S. Application Data
(60) Provisional application No. 61/187,737, filed on Jun. 17, 2009.

(51) Int. Cl. G04B 47/00

(52) U.S. Cl. 368/10

(57) ABSTRACT

A system configured for facilitating timekeeping during the sports game is provided, comprising one or more sensors, a clock configured to display time during the game, and a controller. The sensors are each configured to sense a predefined signal associated with one or more game events during the sports game. The controller is configured to receive information from the sensors regarding a sensed signal, to determine, at least based on the information, that a game event has occurred, and to interface with the clock and control the running thereof, at least in response to the determination of a game event.

### FIELD OF THE INVENTION

This invention relates to game and sports equipment, and in particular to equipment related to timekeeping.

### BACKGROUND OF THE INVENTION

In many timed sports, seconds and even fractions of a second become critical for the final outcome of the game. For example, in basketball, a goal which may determine the outcome may be achieved very close to the end of the game, and whether or not it was achieved within regulation time becomes a critical determination. Thus, referees and other game officials must observe the game extremely closely, and often must resort to a video replay to arrive at the correct determination. Even so, the human eye is limited with respect to the precision with which it can make such a determination.

### SUMMARY OF THE INVENTION

According to one aspect of the present invention, there is provided a system comprising:
one or more sensors, each configured to sense a predefined signal associated with one or more game events during a sports game;
a clock configured to display time during the game; and
a controller configured to:
   receive information from the sensors regarding a sensed signal;
   determine, at least based on the information, that a game event has occurred; and
   interface with the clock and control the running thereof, at least in response to the determination of a game event;
      wherein the system is configured for facilitating timekeeping during the sports game.

It will be appreciated that herein the specification and claims, the term “game event” refers to any event during the game which affects the clock or score, for example an inbound pass, a goal, an out-of-bounds, the release of a ball, the blowing of a whistle, etc.

One or more of the sensors may be:
integrated with equipment configured for use in playing the game; and
configured for detecting a game event associated with the equipment.

The sports game may be basketball. The equipment may comprise a goal, a game event associated with the goal being achieving a score. The goal may comprise a backboard, a rim, a net, and at least two of the sensors constituting goal sensors. The controller may be configured to determine that a score has occurred when the at least two sensors sense a signal in a predetermined sequence.

In particular, the goal may comprise:
a first goal sensor configured to sense a signal associated with the game ball approaching the backboard;
a second goal sensor configured to sense a signal associated with the game ball passing through the rim; and
a third goal sensor configured to sense a signal associated with the game ball passing through the net;
   the controller being configured to determine that a score has occurred when:
the first goal sensor senses the signal before the second goal sensor senses the signal; and
the second goal sensor senses the signal before the third goal sensor senses the signal.

The equipment may further comprise a ball. The ball may comprise one of the sensors constituting a ball sensor, the ball sensor being configured to sense contact or an impact with a foreign object. The ball sensor may comprise a pressure sensor configured to sense a change in internal pressure of the ball. The ball sensor may alternatively or additionally comprise a piezoelectric grid configured to detect changes in the shape of the ball.

The controller may be configured to determine the type of game event associated with the signal sensed by the ball sensor at least partially based on the magnitude thereof.

The ball may further comprise a wireless transceiver to pass information from the ball sensor to the controller. It will be appreciated that herein the specification and claims, the term “transceiver” is used in its broadest sense, including elements configured to both transmit and receive a signal, or only to perform one of those functions.

The equipment may further comprise a whistle. The whistle may comprise one of the sensors constituting a whistle sensor, the whistle sensor being configured to sense a blowing of the whistle.

The equipment may further comprise a court surface. The court surface may comprise one or more of the sensors constituting court sensors, the court sensors being configured to sense impact thereon of one or more of a ball and a player.

The court sensor may be configured to sense the location thereon of the one or more of a ball and a player.

The system may further comprise a video system in communication with the controller, the video system being configured to synchronize video information of the sports game with game events determined by the controller. The video information may comprise a recorded video of at least a portion of the game.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 is a schematic illustration of a system according to the present invention;

FIGS. 2A through 2C are cross-sectional views of different examples of a ball of the system illustrated in FIG. 1;

FIG. 3 illustrates a goal of the system illustrated in FIG. 1;

FIG. 4 is a cross-sectional view of a whistle of the system illustrated in FIG. 1;

FIG. 5 illustrates court sensors of the system illustrated in FIG. 1;

FIG. 6 illustrates a video screen for use with the system illustrated in FIG. 1; and

FIG. 7 illustrates a data presentation unit for use with the system illustrated in FIG. 1.

### DETAILED DESCRIPTION OF EMBODIMENTS

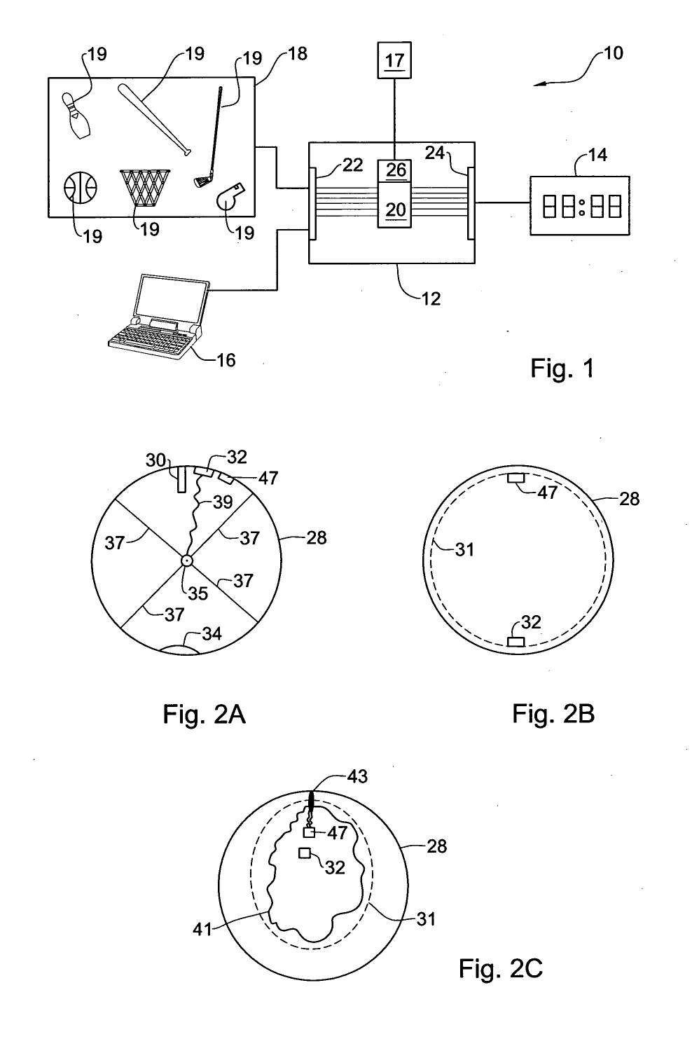

As schematically illustrated in FIG. 1, there is provided a system 10 for facilitating automated or semi-automated timekeeping in a sports match or game. The system comprises a controller 12 in communication with a clock 14 configured to display time during the game, at least one user (e.g., timekeeper) interface 16, one or more articles of equipment 18 used for playing the match or game, and optionally one or more auxiliary sensors 17. The equipment 18 is provided with sensors (schematically indicated by 19) integrated therewith and configured to sense a predefined signal associated with one or more game events, or a game event associated with the equipment, associated with its respective piece of equipment, during the sports game. Lines of communication indicated in FIG. 1 by solid lines may be embodied by wired or wireless connections, as are well known in the art.

The controller 12 is configured to receive instructions and/or signals from the user interface 16 and equipment 18, and to control the operation of the clock 14, at least partially based on the instructions/signals. Thus, it comprises a main processor 20, an input interface 22, and a command interface 24.

The main processor 20 is configured to determine, based at least partially on information received, that a game event has occurred, and interface with the clock 14, e.g., to start and/or stop it, based at least in response to the determination of a game event. In addition, it may comprise the main clock functionality, with the clock 14 itself constituting a “dumb” data presentation unit (i.e., circuitry or computer code to control the timekeeping functionality may be present in the main processor, with the clock 14 simply displaying time as determined by the main processor). The main processor 20 may comprise any suitable processor, and may have instructions hard-coded therein, or comprise a memory module 26, such as flash or any other volatile memory device, associated therewith and containing appropriate instructions. It will be appreciated that the main processor 20 and the memory module 26 may be formed on a single integrated circuit.

The input interface 22 is configured to accept and optionally parse input received from the user interface 16 and equipment 18, and pass it to the main processer 20. Thus, it may comprise interfaces for wired and/or wireless connections. In addition, it may comprise an interface hardwired with the user interface 16, for example if the user interface and main processor 20 are contained within a single unit. In addition to being designed for accepting input, it may be further configured for transmitting output relevant to the received input, such as an acknowledge transmission control character (ACK), a negative-acknowledge character (NAK), or any other similar response message necessary in order to ensure a robust communications link between the main processor 20 and the user interface 16/equipment 18.

The input interface 22 may be further configured for processing input received from the user interface 16 and/or equipment 18 before passing it to the main processor 20. For example, it may be configured to process data corresponding to a predetermined sequence of inputs, and pass a signal based thereon to the main processor 20. This function may be alternatively performed by the controller, or in addition thereto, for example for verification.

The command interface 24 is configured to communicate with the clock 14. Thus, it comprises one or more wired and/or wireless connections controlled directly by the controller 12. Alternatively, a separate clock controller (not illustrated), in communication with the controller 12 and one or more multiple clocks, may be provided. In such a case, the controller 12 interfaces with the clock controller as if it were a clock, with the clock controller being configured for synchronizing the various clocks. The command interface 24 may further comprise an interface hardwired with a clock, for example if they are contained within a single unit.

In addition to communication instructions related to timekeeping, the command interface 24 may be configured to communicate with other data presentation interfaces, such as lights, video displays, buzzers, horns, a public address system, etc. In this way, the controller 12 may be used to control several aspects of game administration in addition to timekeeping.

The clock 14 is typically a countdown timer, and comprises any suitable timekeeping display unit. For example, it may be a large LCD screen, an LED or light-bulb array, etc. It may also be configured to display other information relating to game play, such as score, possession, down and yards-to-go information (e.g., in American football), sub-timers (such as the “shot-clock” in basketball), player information, etc. As noted above, it may comprise circuitry or computer code configured to manage the timekeeping functionality, and receive start/stop/reset/etc. commands from the controller 12, or it may constitute a “dumb” data presentation unit, with the timekeeping functionality performed by the controller, and displaying time as determined thereby.

The user interface 16 allows a timekeeper or other game official to manage the controller 12, facilitating its automated control of the clock 14. As will be described below, the equipment 18 is configured to transmit signals to the controller 12 to indicate that certain game-related events have taken place. Many of these events affect the clock, i.e., the clock should be started or stopped when they occur (for example, the in-bounding of a ball in a basketball game). Parameters relating to various events and their ramifications vis-à-vis the clock are stored in the controller 12, either directly or via the user interface 16. During play, the user indicates, via the user interface 16, which event is about to occur, or has just occurred; the controller 12 then makes a determination regarding the clock (i.e., to start/stop/adjust it), based on the appropriate parameter and the input received. Non-limiting examples will be provided below for clarity.

As noted above, the equipment 18 is configured for detecting and communicating that certain game events have occurred. The equipment may include a ball, a goal (such as a rim in basketball, etc.), whistles, etc.

As illustrated in FIG. 2A, a ball 28 may be provided with an internal pressure sensor 30, a wireless transceiver 32, and a battery 47. The ball 28 may be designed such that the excess weight of the pressure sensor 30 and transceiver 32 are offset by a similar reduction in weight thereof, so that it is still of regulation weight. In addition, a counterweight 34 may be provided so that the ball 28 performs normally, and does not “wobble” or present any other abnormal behavior during play.

The pressure sensor 30 is configured for detecting a sudden and substantial increase in internal pressure of the ball 28, for example as a result of coming in contact with or striking a foreign object (such as the floor or goal) after being thrown, or as a result of being caught or otherwise handled by a player. The pressure sensor 30 may be any suitable sensor known in the art. The pressure sensor 30 further comprises (or is constituted by) a transducer configured to communicate with the wireless transceiver 32. The transducer 32 is configured to transmit information relating to the occurrence of a pressure change, as well as the magnitude thereof.

As illustrated in FIG. 2B, the pressure sensor 30 may be embodied by an indirect pressure sensor. For example, a piezoelectric grid 31 (illustrated schematically by a broken line), configured for detecting and/or measuring deformation of the ball, may be provided on the inner side of the ball membrane to measure changes in the shape of the ball, for example in response to striking an object, being caught, or being released, as described above. This is considered “indirect pressure sensing” since the change in pressure itself is not measured, but rather a condition which would indicate such a change in pressure is detected. The transducer 32 and battery 47 may be provided in any appropriate location(s).

As illustrated in FIG. 2C, the piezoelectric grid 31 may be held in position by an inflatable core 41 (shown in a deflated state) within the ball 28. The grid 31 may be provided built into the core 41, or may be disposed surrounding it. The core 41 may be connected to the valve 43 of the ball 28, such that when the ball is inflated, the core inflates as well, and bears against the inner side of the ball's membrane when fully inflated. The core 41 comprises the transceiver 32, a battery 47, and any other necessary elements. Besides maintaining the positions of elements within the ball 28 at appropriate positions (e.g., at the center of the ball or at other positions so as not to affect the balance thereof during use), the core 41 serves to protect the elements from impacts which occur during use of the ball.

It will be appreciated that a similar core 41 may be provided with the example illustrated in FIG. 2A, i.e., containing therein as well the pressure sensor 30, mutatis mutandis.

According to any example, the valve 43 of the ball 28 may be electrically connected to the battery 47 so as to allow charging thereof via the valve. In particular, electrical contacts (not illustrated) are provided on the valve to facilitate connection to a suitably designed charger for recharging the battery 47. The battery 47 may be designed to have a capacity sufficient for use during an entire game.

The pressure sensor 30 may be calibrated to determine what type of game event precipitated the pressure change, for example based on the magnitude of the change. Alternatively or additionally, the input interface 22 and/or main processor 20 may be configured to make this determination based on information relating to the magnitude of the pressure change received thereby,

In addition or alternatively, a load cell 35 may be provided in the center of the ball, suspended with tension cables 37 running along three mutually perpendicular axes of the ball 28. The load cell 35 is configured to detect slight changes in stress of each of the cables 37, thus facilitating detection of slight changes in movement of the ball, for example due to a brushing against or low-speed impact with an object. The load cell 35 is further configured to communicate with the wireless transceiver 32, either by a wireless connection or via a wire 39 provided for this purpose. It will be appreciated that one of the tension cables 37 may be configured for use as a communication wire between the load cell 35 and the wireless transceiver.

It will further be appreciated that one or both of the pressure sensor 30 and load cell 35 may be provided, or any other means for detecting contact or impact of the ball with another object.

The wireless transceiver 32 is configured to communicate with the input interface 22 of the controller 12. It may either transmit the information furnished to it by the pressure sensor, which is then interpreted by the main processor 20, or be configured to analyze the information before sending. For example, it may be configured to send only data which meets or exceeds a predefined threshold, for example only sending a yes/no, or other simplified message.

As illustrated in FIG. 3, a goal 36 (in this case a basketball rim/net), comprising a backboard (not illustrated) and a rim 44 carrying a net 42, may be provided with a sensor for detecting that a goal or score has been achieved. In addition, it comprises a transceiver 38 (wired or wireless) configured to communicate with the input interface 22 of the controller 12.

For example, the sensor may be in the form of an expandable ring 40 located on the net 42, at a position sufficiently below the rim 44 to ensure that play will not be affected. The ring 40, in its relaxed position, may be slightly smaller than the ball, and expand when a goal is achieved. This is detected and transmitted to the controller 12 by the transceiver 38.

Alternatively or in addition to the above, a set of three short range motion detectors 45a, 45b, 45c may be provided at positions above, level with, and below the rim 44, respectively. A goal may be registered as having occurred when all three detect motion in sequence, i.e., 45a before 45b, and 45b before 45c. The short range motion detector 45a which is disposed above the rim may be mounted so as to detect a ball approaching the backboard.

The controller 12 may be configured so as to register a goal only when a proper sequence of detections have taken place. For example, a detection by short range motion detector 45a must precede a detection by short range motion detector 45b which must precede a detection by short range motion detector 45c before a goal is registered. Alternatively, a dedicated controller (not indicated) associated with the three short range motion detectors 45a, 45b, 45c may be provided to detect the detections and the sequence, and transmit a signal to the controller 12 that a goal has occurred.

It will be appreciated that any other appropriate means for detecting a goal may be provided.

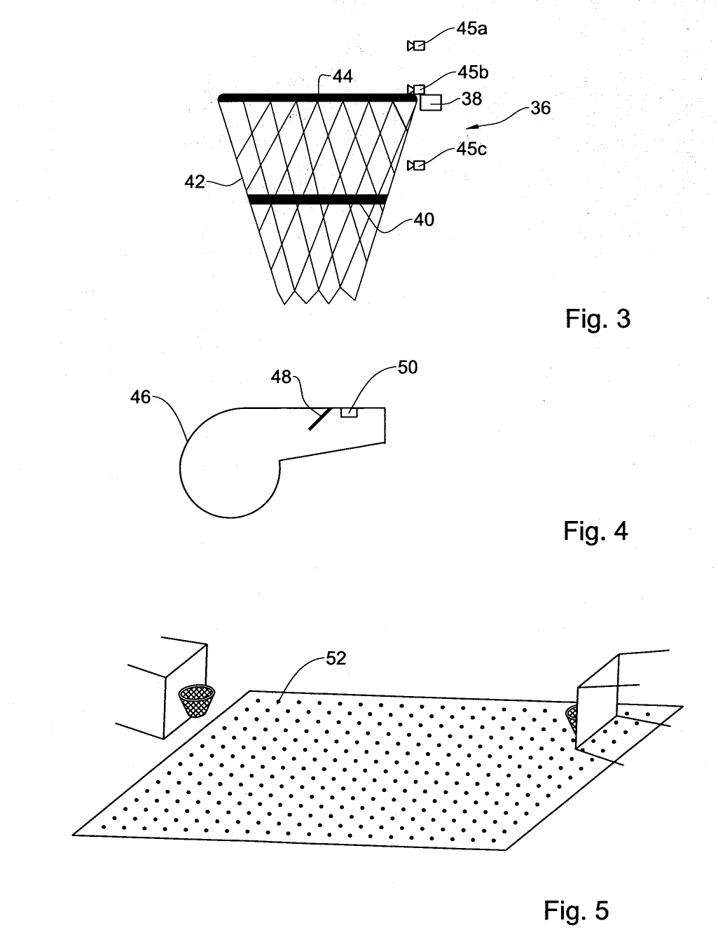

As illustrated in FIG. 4, a whistle 46 may be provided with a sensor 48 to detect when air has been blown therein at a sufficient force to produce a sound. The sensor 48 is configured to communicate with a wireless transceiver 50, which is configured to communicate with the input interface 22 of the controller 12. Alternatively or in addition, the whistle may be configured to transmit a sound of a predetermined frequency which the input interface 22 is configured to detect.

The auxiliary sensors 17 may include sensors built into the court or playing field. For example, sensors, such as photoelectric sensors, may be located around the court or playing field so as to determine when an out-of-bounds condition occurs. In addition, the court or playing field may be provided with means for detecting the presence, location, and/or force exerted by objects thereof. This may be accomplished, as illustrated in FIG. 5, by providing an array of court sensors 52 above or just below the surface of the court or playing field. Detections of the court sensors 52 may be used to detect and differentiate between an impact detected by the ball 28 which occurs from a floor impact from those occurring from impact with a player, as well as inform the controller as to the location of the floor impact.

Prior to use, parameters are stored in the controller 12, along with the implications of each. For example, start of play of a basketball game may be determined by when the ball is legally tapped by a jumper on the jump ball. Thus, the parameter would be to detect such a tap and then start the clock. During use, immediately prior to the jump ball, the timekeeper indicates, via the user interface 16, that a jump ball is about to occur, initiating operation as per the appropriate parameter. The controller 12 receives this information, and begins the clock when the tap is detected. Similar methods are employed to start the clock when the ball has been in-bounded, or to stop the clock when a goal has been achieved. In addition, the controller 12 may be configured to stop the clock when it has been determined that a referee or other game official has blown his whistle 46.

The system 10 can thus be considered “semi-automated”, since while the starting/stopping of the clock is automated, it only occurs when the timekeeper indicates that it should take place.

The controller 12 may further be configured to adjust the time on the clock. For example, if a game event has occurred before the timekeeper has indicated that it would occur, he may review the inputs received by the controller 12, and indicate post facto the type of event that occurred. The controller 12 then adjusts the clock accordingly. For example, if a ball is in-bounded before the timekeeper indicates that it is about to be in-bounded, he may indicate which signal received from the ball is associated with the appropriate event for restarting the clock.

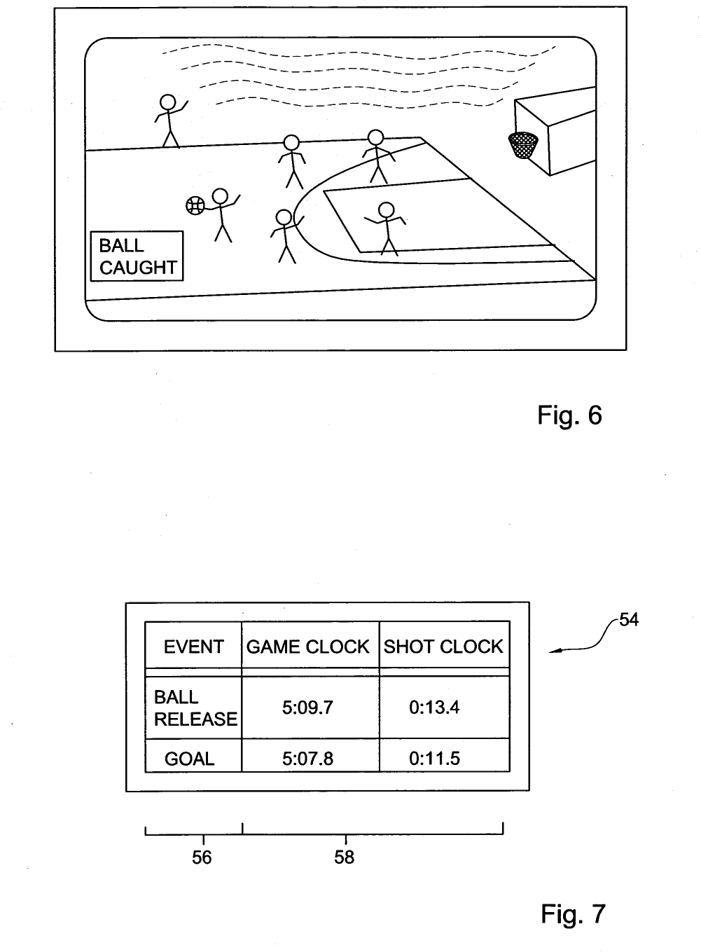

According to a modification, the system is integrated with a video system for facilitating adjusting the time. The system synchronizes video information about the game, such as a recorded video thereof, with the signals received from the equipment. For this purpose, it may communicate with the controller 12, for example a storage system thereof, in order to retrieve information relating to game information, including game events. In the above example, the user may review the video of the game, specifically the portion thereof when the ball was in-bounded. While viewing the video, indications may be displayed on-screen corresponding to the signals received from the equipment 18 (see FIG. 6). The indications may be displayed in real-time, and selectively enabled/disabled and moved around the screen so as not to interfere with viewing a relevant portion of play. This facilitates identifying the events which correspond to each signal.

In addition, the main processor 20 may be configured for interfacing with the video system so as to allow reviewing the game or a portion thereof in synchronization with signals received by the input interface 22, thus allowing a game official to visually review a recording of the game or a portion thereof with information regarding game events displayed or otherwise indicated at the appropriate chronological position.

As illustrated in FIG. 7, a data presentation 54 unit may be provided. The data presentation unit 54 may be configured to present game information 56 along with corresponding time information 58 which is determined by the controller 12.

Those skilled in the art to which this invention pertains will readily appreciate that numerous changes, variations and modifications can be made without departing from the scope of the invention mutatis mutandis.

1.-20. (canceled)

21. A system comprising:
one or more sensors, each of the one or more sensors configured to sense a predefined signal associated with one or more game events during a sports game;
a clock configured to display time during the game; and
a controller configured to:
receive information from the one or more sensors regarding a sensed signal;
determine, at least based on the information, that a game event has occurred; and
interface with the clock and control the running thereof, at least in response to the determination of a game event;
wherein the system is configured for facilitating timekeeping during the sports game.

22. The system according to claim 21, wherein one or more of the one or more sensors are:
integrated with equipment configured for use in playing the game; and
configured for detecting a game event associated with the equipment.

23. The system according to claim 22, wherein the sports game is basketball.

24. The system according to claim 23, wherein the equipment comprises a goal, a game event associated with the goal being achieving a score.

25. The system according to claim 24, wherein the goal comprises a backboard, a rim, a net, and at least two of the one or more sensors constituting goal sensors.

26. The system according to claim 25, wherein the controller is configured to determine that a score has occurred when the at least two of the one or more sensors sense a signal in a predetermined sequence.

27. The system according to claim 26, wherein the goal comprises:
a first goal sensor configured to sense a signal associated with the game ball approaching the backboard;
a second goal sensor configured to sense a signal associated with the game ball passing through the rim; and
a third goal sensor configured to sense a signal associated with the game ball passing through the net;
the controller being configured to determine that a score has occurred when:
the first goal sensor senses the signal before the second goal sensor senses the signal; and
the second goal sensor senses the signal before the third goal sensor senses the signal.

28. The system according to claim 23, wherein the equipment comprises a ball.

29. The system according to claim 28, wherein the ball comprises one of the one or more sensors constituting a ball sensor, the ball sensor being configured to sense contact with a foreign object.

30. The system according to claim 29, wherein the ball sensor comprises a pressure sensor configured to sense a change in internal pressure of the ball.

31. The system according to claim 29, wherein the ball sensor comprises a piezoelectric grid configured to detect changes in the shape of the ball.

32. The system according to claim 29, wherein the controller is configured to determine the type of game event associated with the signal sensed by the ball sensor at least partially based on the magnitude thereof.

33. The system according to claim 29, wherein the ball comprises a wireless transceiver to pass information from the ball sensor to the controller.

34. The system according to claim 23, wherein the equipment comprises a whistle.

35. The system according to claim 34, wherein the whistle comprises one of the one or more sensors constituting a whistle sensor, the whistle sensor being configured to sense a blowing of the whistle.

36. The system according to claim 23, wherein the equipment comprises a court surface.

37. The system according to claim 36, wherein the court surface comprises one or more of the one or more sensors constituting court sensors, the court sensors being configured to sense impact thereon of one or more of a ball and a player.

38. The system according to claim 35, wherein the court sensor is configured to sense the location thereon of the one or more of a ball and a player.

39. The system according to claim 21, further comprising a video system in communication with the controller, the video system being configured to synchronize video information of the sports game with game events determined by the controller.

40. The system according to claim 39, wherein the video information comprises a recorded video of at least a portion of the game.
